(19) United States
(12) Patent Application Publication
(10) Pub. No.: US 2011/0135558 A1
(43) Pub. Date: Jun. 9, 2011

(54) PROCESS FOR PRODUCING SILICON CARBIDE

(76) Inventors: Ding Ma, Liaoning (CN); Lijun Gu, Liaoning (CN); Xinhe Bao, Liaoning (CN); Wenjie Shen, Liaoning (CN)

(21) Appl. No.: 12/736,898

(22) PCT Filed: May 18, 2009
(86) PCT No.: PCT/CN2009/000530

§ 371 Date: Feb. 4, 2011

(30) Foreign Application Priority Data
May 21, 2008 (CN) PCT/CN2008/000979

(51) Int. Cl. C01B 31/36

(52) U.S. Cl. 423/345

(57) ABSTRACT

A process for producing porous silicon carbide comprising mixing particles of silicon carbide reactant with particles of carbon, and calcining the mixture in an atmosphere comprising molecular oxygen at a temperature in excess of 950° C., wherein the silicon carbide:carbon mass ratio in the mixture is in the range of from 5:1 to 1:10.

This invention relates to the production of silicon carbide, more specifically to a process for producing a silicon carbide foam.

Silicon carbide has high mechanical strength, high chemical and thermal stability, and a low thermal expansion coefficient. For this reason, it is attractive as a support for catalysts, particularly in high temperature reactions.

Ivanova et al in J. Amer. Chem. Soc., 2007, 129 (11); 3383-3391 and J. Phys. Chem. C, 2007, 111, 4368-74 describes a catalyst comprising silicon carbide and zeolite ZSM-5, and use of the catalyst in methanol to olefins reactions. The silicon carbide is in an extruded form or as a foam.

Often, a desirable feature of catalysts supports is high surface area and high porosity, which enables high catalyst loading and dispersion on the support, and also reduces diffusional restrictions. Although silicon carbide generally has low porosity and surface area, the silicon carbide used by Ivanova in the above-cited documents was prepared using the method of Ledoux et al, as described in U.S. Pat. No. 4,914,070 and in J. Catal., 114, 176-185 (1988). This method involves the reaction of silicon with silicon dioxide at 1100 to 1400° C. to form SiO vapour, which is subsequently contacted with reactive and divided carbon with a surface area of at least 200 m²g⁻¹ at 1100 to 1400° C. The resulting SiC material is an agglomeration of SiC particles with a surface area of at least 100 m²g⁻¹. Ledoux reports the resulting SiC as a suitable component in car exhaust catalysts and in hydrodesulphurisation catalysts.

A further method of preparing porous SiC materials is reported by Wang et al in J. Porous Mater., 2004, 11 (4), 265-271, in which a silicon carbide precursor, such as polymethylsilane, is deposited onto a template selected from cellulosic fibres, carbon nanotubes, carbon fibres, glass fibres, nylon fibres or silica, and subsequently curing and pyrolising the mixture under inert atmosphere. The templates are removed by HF etching in the case of silica or glass or by calcination in air at 650° C. for the carbon-based and organic templates.

Sun et al, in J. Inorg. Mater., 2003, 18 (4), 880-886, describe a process in which silicon carbide powder and dextrin are ground together, shaped, and burned in an oxygen atmosphere at 1400° C. to produce porous silicon carbide.

EP-A-1 449 819 describes a process for producing porous silicon carbide in which a slurry comprising silicon powder and a resin functioning as a carbon source is applied to a spongy porous body, such as paper or plastic, and carbonised at 900 to 1320° C. under vacuum or inert atmosphere. Molten silicon is then applied to the resulting structure at 1300 to 1800° C. under vacuum or inert atmosphere.

U.S. Pat. No. 6,887,809 describes a process for preparing open-celled silicon carbide foam by preparing a suspension of silicon carbide particles and particles of sintering additives such as boron, carbon or boron/aluminium/carbon, coating the suspension onto a foam network material, such as a polyurethane foam, or fibres of other organic synthetic or natural materials, and heating the coated material under an inert atmosphere or vacuum at >1800° C.

Zhang et al in Guisuanyan Tongbao (2000), 19 (5), 40-43 describe the production of porous silicon carbide by heating a mixture of SiC, carbon and an Al₂O₃/K₂O/SiO₂ binder to temperatures of 1160° C. to 1320° C.

Suwanmethanond et al, in Ind. Eng. Chem. Res., 2000, 39, 3264-3271, describe the production of porous silicon carbide by heating particles of silicon carbide and sintering aid under an argon atmosphere. Use of carbon as a sintering aid is stated to be difficult, and use of boron carbide and phenolic resin are more effective in producing good porosity and transport characteristics.

Fitzgerald et al, in J. Mater. Sci, 30 (1995), 1037-1045, describe the formation of microcellular SiC foams by first creating a polycarbosilane foam by treating porous salt compacts with polycarbosilane under pressure and under an argon atmosphere, and removing the salt by leaching with water over a period of three weeks. The polycarbosilane foam is then oxidised at 100-190° C., and subsequently pyrolised to produce the SiC foam.

Kim et al in J. Am. Ceram. Soc., 88 (10), 2005, 2949-2951 describe a process for producing microcellular SiC ceramics by pressing a mixture of polysiloxane, phenol resin, polymeric microbeads and Al₂O₃—Y₂O₃ into a disc, heating to 180° C. in air, subsequently pyrolising under nitrogen at 1200° C., and then heating to 1650° C. under argon.

Studart et al in a review in J. Am. Ceram. Soc., 89 (6), 2006, 1771-1789, describe the use of sacrificial template methodologies to create porous ceramics, in which a typically biphasic composite is prepared comprising a continuous matrix of ceramic particles or ceramic precursors and a sacrificial phase dispersed through the matrix thereof, the sacrificial phase ultimately being extracted to generate pores within the ceramic structure.

JP 2000-109376A describes a process in which an aqueous slurry of silicon carbide powder, carbon powder and an organic binder is dried and calcined under vacuum or under an inert atmosphere, the resulting product being treated with molten silicon to provide a porous ceramic.

JP 11335172A describes a process in which SiC and C powder are dispersed in water and applied to a cast at a pH of 6-11, and heat treated under a non-oxidising gas at 1500-2100° C. to produce ceramics with high porosity.

Rambo et al, in Carbon, 43, 2005, 1174-1183, describe the production of porous carbides, such as silicon carbide, by adding an oxide sol to pyrolised biological material, such as pine-wood, drying the sol, and pyrolising the oxide/biocarbon mixture under argon.

EP-A-1 741 687 describes a process for producing a porous SiC-containing ceramic material by preparing a moulded and shaped porous body made from carbon particles, contacting the moulded shaped porous body with silicon or a silicon-containing compound, preferably under an oxygen-free atmosphere or under vacuum, and heating to produce a shaped, porous silicon carbide structure.

CN 1793040 describes a process in which silicon carbide, a binding agent, and sodium dodecyl benzene sulfonate as a pore forming material are ground, pressed, moulded, and sintered at 1280-1360° C.

Colombo, in Phil. Trans. R. Soc. A (2006), 364, 109-124, reviews methods of preparing porous ceramic materials, and describes methods for preparing porous SiC using sacrificial foam templates, such as polyurethane foam, or by reacting porous carbon templates with Si or Si compounds such as gas phase SiO or CH₃SiCl₃, or by reaction with a sol containing colloidal silica followed by high temperature treatment.

Although SiC foams with interconnecting void spaces can be made, they can often suffer from poor mechanical stability due the architecture of the SiC framework being too fragile. This problem has been addressed in EP-A-1 382 590, by forming a polymeric matrix, submerging it in a suspension of silicon and a viscous solvent, evaporating the solvent and slowly pyrolising the resulting mass at 500° C. to produce a SiC framework, which is then strengthened by coating the framework with an organic source of silicon, and further pyrolising the material at a temperature in excess of 1000° C.

Other methods of treating silicon carbide in combination with carbon include the method described in JP 2007-230820A, which relates to a process for producing a SiC sintered compact, in which a porous, carburized carbon powder is mixed with silicon carbide powder, moulded, and degreased by heating to 600-1100° C. in a reduced-pressure air atmosphere, or a normal-pressure inert gas atmosphere. The resulting material is then sintered under a reduced-pressure air atmosphere, or a normal-pressure atmosphere using inert gases, at temperatures of 1800-2200° C.

WO 03/031542 and WO 03/066785 both describe processes for preparing carbon foam abrasives, in which a finely powdered carbide precursor, such as silicon, is incorporated into a coal powder and converted into the carbide by heating under a non-oxidizing atmosphere.

US 2006/0003098 describes the production of densified and essentially non-porous silicon carbide by filling a silicon carbide preform with open porosity with a carbon precursor and heating to produce a filled silicon carbide preform, and is then further heated to produce a carbonaceous porous structure within the silicon carbide preform. The filled structure is then contacted with silicon in an inert atmosphere at a temperature above the melting point of silicon, which reacts with the carbon and forms a dense, filled silicon carbide structure.

US 2006/0046920 describes a process for making sintered silicon carbide in which silicon carbide particles are dispersed in a solvent, poured into a mold, dried and calcined under vacuum or inert atmosphere. The calcined body is then impregnated with a carbon source, such as a phenolic resin, impregnated with molten silicon, and heated under vacuum to obtain a silicon carbide body.

JP 2007-145665 describes a process for preparing a porous sintered SiC compact, in which particles of SiC, C and a binding agent are mixed together and extruded, degreased by heating to 500° C., followed by silicification using gaseous SiO under an argon atmosphere at 1900° C.

JP 7-33547 describes a process for producing a porous silicon carbide sintered compact by mixing SiC and carbon particles, sintering the mixture using plasma discharge under an argon atmosphere at 1600-2300° C., and then heating the resulting solid under an oxidising atmosphere at 600-800° C.

IE 912807 describes a process for silicizing a porous molding of silicon carbide/carbon by mixing silicon carbide powder, organic binder and carbon, and heating to 1000° C. under a non-oxidising atmosphere. The resulting material is silicized by treatment with molten silicon.

There remains a need for an alternative method of producing porous silicon carbide with high pore volumes using fewer synthesis steps, while providing control over the properties and morphology of the resulting material.

According to the present invention, there is provided a process for producing porous silicon carbide comprising mixing particles of silicon carbide reactant with particles of carbon, and heating the mixture in an atmosphere comprising molecular oxygen at a temperature in excess of 950° C., wherein the silicon carbide:carbon weight ratio is in the range of from 5:1 to 1:10.

The silicon carbide material produced by the process of the present invention has a porous structure, and typically adopts a foam- or sponge-like structure. It is produced by taking a particles of silicon carbide, herein referred to as silicon carbide reactant, mixing them with particles of carbon, and heating the particulate mixture in a molecular oxygen-containing atmosphere at high temperature. The porosity in the resulting porous silicon carbide material is typically in the form of voids or cavities in the silicon carbide framework structure, the quantity, size and connectivity of which can be controlled by varying the particle size, particle shape and/or weight ratios of the silicon carbide reactant and carbon particles. For example, generally spherical carbon particles typically create spherical voids or cavities in the resulting silicon carbide structure. Typically, the silicon carbide reactant is a powdered form of non-porous silicon carbide.

There is no need to add any other solid components to the mixture of silicon carbide reactant and carbon particles, and hence in one embodiment of the invention, the mixture of particles consists of only silicon carbide reactant and carbon particles. This reduces the complexity of the synthetic procedure, by reducing the need for additional solid components.

In one embodiment of the invention, a liquid is mixed with the particulate mixture of silicon carbide reactant and carbon particles to form a paste, the liquid typically being easily removed by drying at relatively low temperatures. Examples of liquids that can be used to produce a paste include ethanol and/or water. Mixing the particles as a paste can help ensure a more homogeneous distribution of the particles.

Optionally, the mixture of silicon carbide reactant particles and carbon particles can undergo a pre-calcination procedure, wherein it is heated under an atmosphere comprising molecular oxygen to a temperature typically at or below 950° C. This pre-calcining treatment can act to harden the mixture, and makes the resulting composite more mechanically robust than the initial mixture of particles, and more easy to shape. Where pre-calcination is performed, it is typically carried out at temperatures of 600° C. or more, for example 750° C. or more, for example in the range of from 600 to 950° C., or 750 to 950° C. In pre-calcination, silicon oxide species are observed in the X-ray diffraction pattern of the material, and carbon is still present in the structure. Optionally, for example if the initial mixture of silicon carbide reactant and carbon particles are in the form of a paste, the paste is first dried, for example at a temperature of up to 200° C., for example in the range of from 50 to 200° C., before the pre-calcination or calcination.

Pre-calcination, where used, can harden the mixture of silicon carbide reactant particles and carbon particles, but the material can be still further hardened by calcination under an oxygen-containing atmosphere at temperatures in excess of 950° C., preferably at a temperature of 1000° C. or more, for example 1100° C. or more, such as 1400° C. or more. The temperature is also suitably maintained at 1600° C. or less, for example 1500° C. or less. Suitable temperature ranges for the calcination are in the range of from 1100 to 1600° C., for example in the range of from 1400 to 1500° C. Calcination above 1000° C. increases the concentration of silicon oxide species compared to lower temperature treatments.

Calcination and/or pre-calcination can be carried out at 0.1 bara (10 kPa) or more, and preferably 0.5 bara (50 kPa) or more. Suitably, the pressure is. atmospheric pressure, or greater than atmospheric pressure, for example in the range of from 1 to 100 bara (0.1 to 10 MPa), such as 1 to 10 bara (0.1 to 1 MPa) or 1 to 5 bara (100 to 500 kPa). Lower pressures are not typically used as vacuum generating equipment is required, which adds to the complexity and operating costs of the process, and removal of the carbon through combustion is less efficient.

The oxygen partial pressure can be 0.1 bara (10 kPa) or more, for example 0.15 bara (50 kPa) or more, or 0.2 bara (20 kPa) or more, and can be up to 20 bara (2 MPa), for example up to 10 bara (1 MPa) or up to 5 bara (0.5 MPa).

Without being bound by theory, it is thought that the hardening of the pre-calcined material compared to the non-thermally treated material is a result of the formation of Si—O species and/or amorphous silica species on the surface of the silicon carbide reactant, which can cross-link between particles and/or act as a binder between particles, which thereby renders the macroscopic structure more robust. At higher temperature calcination, the concentration of surface Si—O species and/or silica is increased, which allows a greater extent of cross-linking, and hence increases further the mechanical strength of the material.

Another advantage associated with the presence of surface Si—O species is that it can result in higher strength composite materials to be formed between silicon carbide and other oxides. For example, to produce a thermally robust catalyst, one may wish to combine the advantages of a metal oxide catalyst or catalyst support with the mechanically robust properties of silicon carbide. By producing silicon carbide with surface silicon oxide species, improved chemical cross-linking between the Si—O species of the silicon carbide material and the surface of the oxide material can improve the mechanical and thermal robustness of the metal oxide catalyst or support. An example of where this may be used is in the production of zeolite/silicon carbide catalysts, an example being Mo-containing zeolite catalysts which can be useful in the dehydroaromatisation of methane to aromatic compounds, as described in a co-pending patent application.

Thus, the present invention is able to produce, in situ, as opposed to through post-treatment, a porous silicon carbide material that comprises silicon oxide species, which are useful in the preparation of SiC-oxide composite materials, for example for producing an SiC composite with an oxide catalyst or catalyst support, or alternatively which can enable SiC to be used directly as a catalyst support.

The ratio of particle sizes and the weight ratio of the silicon carbide reactant and carbon particles can be modified to control the pore size, pore connectivity, and pore volume of the resulting porous silicon carbide.

Typically, the particle sizes of the silicon carbide reactant and carbon materials are chosen so that the carbon particles are larger than the silicon carbide reactant particles. In one embodiment, the average diameter of the carbon particles is at least ten times that of the silicon carbide reactant particles, and in a further embodiment at least 50 times that of the silicon carbide reactant particles.

Typically, the average diameter of the silicon carbide reactant particles is up to 50 μm and at least 0.05 μm. In one embodiment, the average diameter of the silicon carbide reactant particles is 5 μm or less, such as 1 micron or less. In a further embodiment, the silicon carbide reactant particles have an average particle diameter of 0.5 μm.

The carbon particles typically have an average diameter of up to 100 μm, and at least 0.1 μm. In one embodiment, the average particle diameter of the carbon is greater than 10 μm, for example greater than 20 μm. In a further embodiment the carbon particles have an average particle diameter of 32 μm.

The weight ratio of silicon carbide reactant to carbon particles is typically in the range of from 5:1 to 1:10, for example in the range of from 4:3 to 1:10, such as in the range of from 1:1 to 1:5. Lower silicon carbide to carbon weight ratios tend to favour a more porous, open resulting silicon carbide structure with increased pore volume.

Pre-calcination and calcination are carried out in the presence of molecular oxygen. The atmosphere of the calcination can be pure oxygen, or a gaseous mixture comprising oxygen, for example air. The source of molecular oxygen does not need to be dry, although optionally it can be dried before use in calcination or pre-calcination, for example by passing the source of a molecular oxygen-containing gas over a dried molecular sieve.

There now follow non-limiting examples illustrating the invention, with reference to the Figures in which:

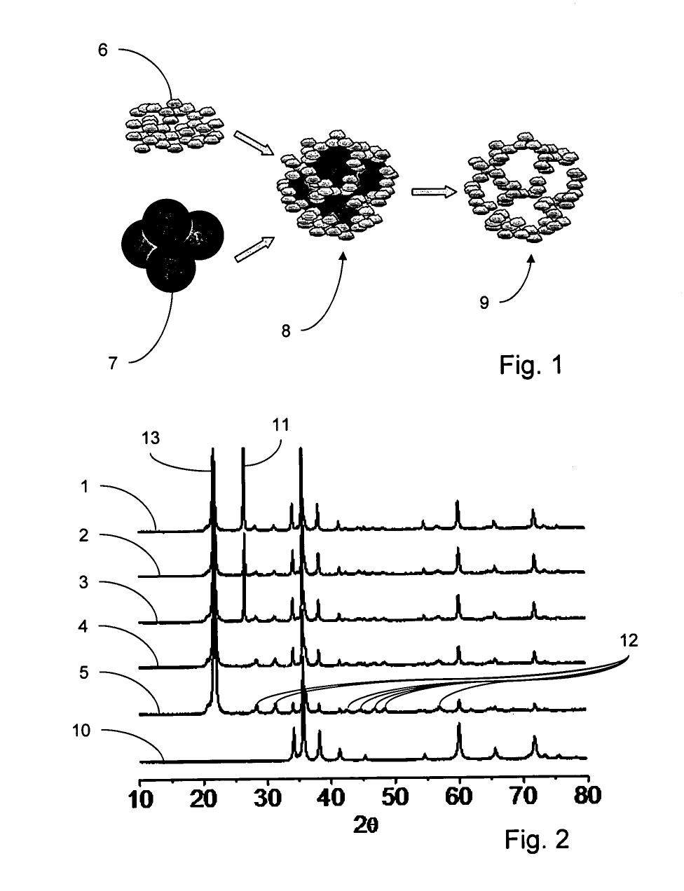

FIG. 1 schematically illustrates a process for forming porous silicon carbide according to the present invention.

FIG. 2 shows X-ray diffraction patterns for a silicon carbide and carbon mixture at various stages of a process according to the invention.

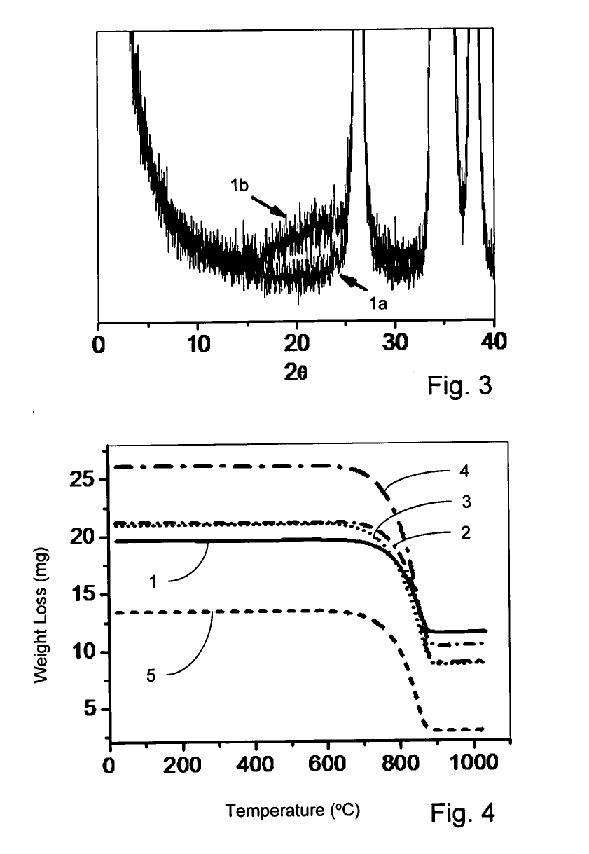

FIG. 3 is an expanded view of X-ray diffraction patterns of one of the samples before and after pre-calcination at 900° C.

FIG. 4 is a series of plots showing weight loss of various mixtures of silicon carbide and carbon particles when heated in the presence of air.

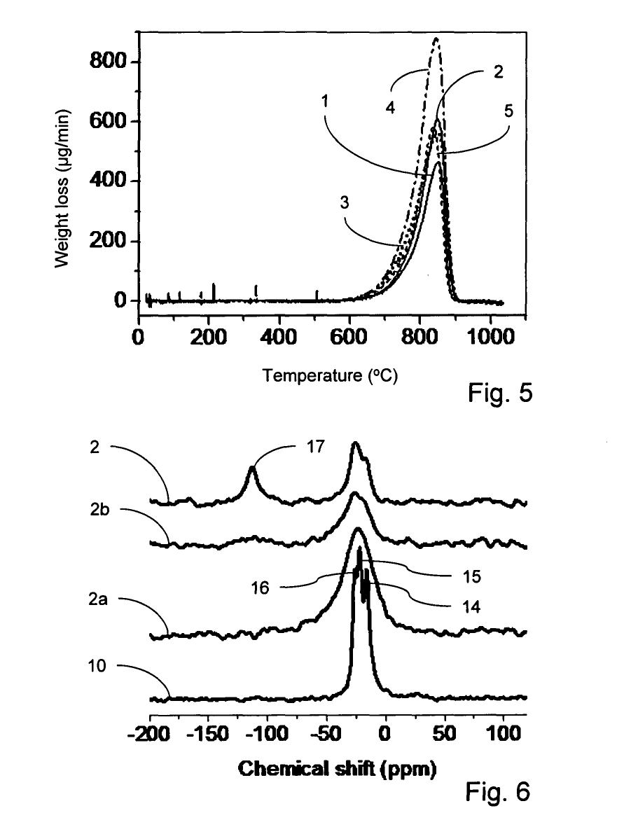

FIG. 5 shows the change in weight of various mixtures of silicon carbide and carbon particles with time, when heated in the presence of air.

FIG. 6 shows ²⁹Si MAS NMR spectra at various stages of synthesis of a mixture of silicon carbide to carbon at a weight ratio of 4:3

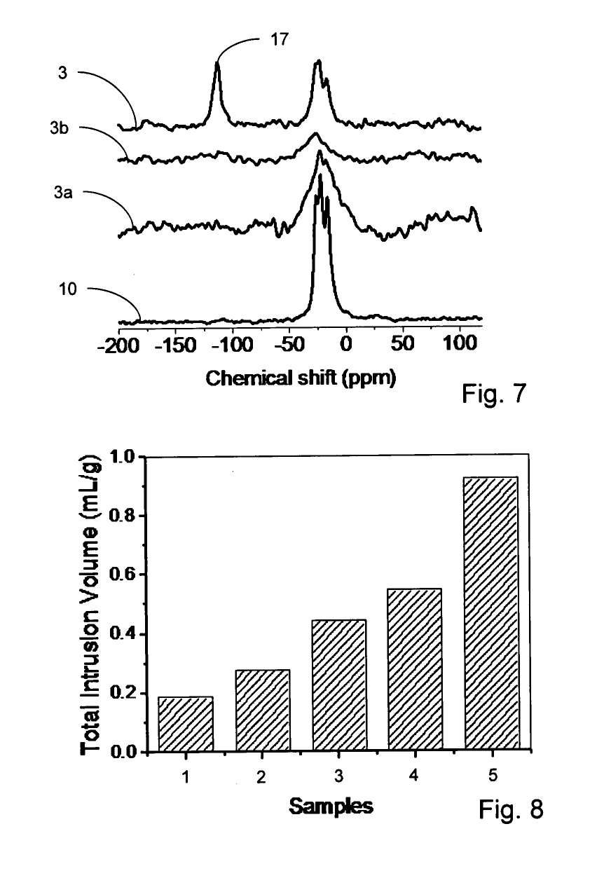

FIG. 7 shows ²⁹Si MAS NMR spectra at various stages of synthesis of a mixture of silicon carbide to carbon at a weight ratio of 3:4.

FIG. 8 shows total intrusion volumes of various porous SiC materials after calcination as measured by mercury porosimetry.

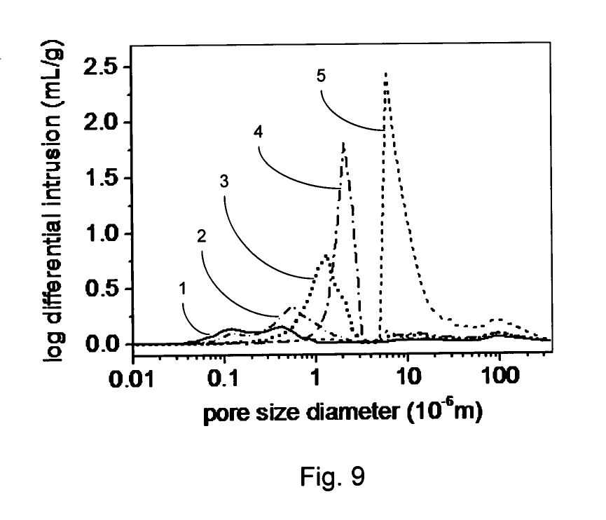

FIG. 9 shows average pore diameter of various porous SiC materials after calcination as measured by mercury porosimetry.

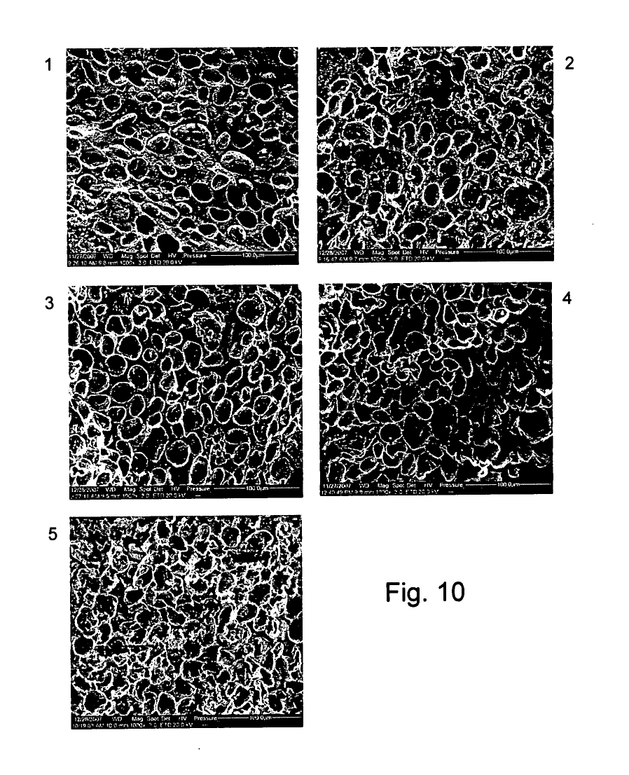

FIG. 10 shows scanning electron micrographs of various porous SiC materials after calcination.

Solids were analysed at various stages of synthesis by X-ray diffraction at room temperature, using a Rigaku RINT D/MAX-2500/PC diffractometer employing Cu K_{α} radiation, operating at 40 kV and 200 mA.

Scanning Electron Micrographs of calcined porous SiC materials were collected using a FEI Quanta 200 F field emission microscope working at 0.5-30 kV, with a resolution of 2 nm. Samples were mounted on a conductive adhesive tape, and a 10 nm gold coating was applied.

Pore size distribution and pore volumes were determined by mercury intrusion porosimetry using a Micromeritics Autopore 9500 apparatus, operating at a maximum pressure of 228 MPa, and covering a range of pore size diameters between 5 nm and 360 μm.

Thermogravimetric analysis and Differential Thermogravimetric Analysis was carried out using a Perkin Elmer Pyrus Diamond TG/DTA device, using a heating rate of 5° C. min⁻¹ and a flow of air. The samples were pre-dried at 120° C. before analysis.

²⁹Si Solid state magic angle spinning nuclear magnetic resonance (MAS-NMR) spectra were collected using a Varian Infinity-plus 400 MHz spectrometer, using a sample spinning rate of 4 kHz.

In the following examples, the SiC was provided as a powder obtained from Shandong Qingzhou Micropowder Co. Ltd, and the carbon used was obtained as pellets from the Tianjin Tiecheng Battery Material Co. Ltd.

### EXAMPLE 1

Silicon carbide powder with an average particle diameter of 0.5 μm and carbon particles with an average particle diameter of 32 μm were mixed in a SiC:C weight ratio of 4:3, and were ground together in a mortar for 10 minutes. The mixture was transferred to a crucible, and deionised water was added with mixing to form a sticky cake with a thickness of 2 to 3 mm. This was left at room temperature overnight.

The solid was then heated in the presence of air to a temperature of 120° C. over a period of 3 hours, and held at 120° C. for 2 hours before being allowed to cool, in order to remove excess water from the sample.

The solid was then pre-calcined by heating it in air to a temperature of 900° C. over a period of 10 hours, and held at 900° C. for 4 hours. The resulting solid was carefully ground and sieved. Granules between 10-20 mesh size were collected.

The granules were transferred to an alumina crucible and calcined in air by heating to 1450° C. at a rate of 2° C. min⁻¹, and holding the solid at that temperature for 8 hours before being allowed to cool to room temperature.

### EXAMPLE 2

The procedure of Example 1 was followed, except that the SiC:C weight ratio was 4:4.

### EXAMPLE 3

The procedure of Example 1 was followed, except that the SiC:C weight ratio was 3:4.

### EXAMPLE 4

The procedure of Example 1 was followed, except that the SiC:C weight ratio was 2:4.

### EXAMPLE 5

The procedure of Example 1 was followed, except that the SiC:C weight ratio was 1:4.

FIG. 1 schematically illustrates a proposed mechanism by which the porous silicon carbide is formed. Silicon carbide reactant particles, 6, and carbon particles, 7 are intimately mixed, optionally in the presence of water, to produce a mixture 8 in which silicon carbide reactant particles surround the carbon particles. The silicon carbide reactant particles are preferably smaller than the carbon particles to improve the connectivity between silicon carbide particles and hence the mechanical strength of resulting porous silicon carbide.

The material is then calcined in air, optionally with pre-calcination, to remove the carbon particles, by combustion to carbon oxides, and leaving a silicon carbide porous framework 9.

FIG. 2 shows X-ray diffraction (XRD) patterns for Examples 1 to 5 (labelled 1, 2, 3, 4 and 5 respectively), additionally with the XRD pattern for the silicon carbide reactant 10. In Examples 1 to 3 a peak, 11, at a 2θ angle of 26.5° is present, attributed to carbon that has not been removed due to calcination. It is thought that the porous structure of the SiC in these materials is not sufficiently connected to enable removal of carbon not accessible to the surface of the porous SiC crystals or particles. This peak is not present in Examples 4 and 5, which were prepared using a lower SiC:C weight ratio, and it is thought that the porous structure in these materials is more open and the pore structure more connected, reducing the chances of carbon particles being trapped in inaccessible regions of the SiC structure.

In Examples 1 to 5, there is a series of peaks, 12, which are not present in the SiC reactant. These are attributed to SiOₓC_{y} species, i.e. silicon-oxide species which are part of the SiC framework. This is also consistent with the calcination causing the formation of surface Si—O species.

In Examples 1 to 5, there is also a peak, 13, at a 2θ angle of 21.8° which is also not present in the SiC reactant, and is attributed to silica. Silica is believed to form occur as a result of oxidation of silicon carbide during calcination. The sharpness and intensity of the peak is indicative of it being crystalline in nature.

FIG. 3 shows the x-ray diffraction pattern of Example 1 before calcination, 1a, and after pre-calcination at 900° C. (but before calcination), 1b. A very small and broad silica peak is present in the pre-calcined sample 1b, which is significantly less intense than after calcination at 1450° C., and resembles more closely an amorphous silica phase as opposed to a crystalline phase. In addition, peaks corresponding to the SiOₓC_{y} species do not appear to be present in the pre-calcined sample, which implies that they are either not present, or that their concentration is very low. Thus, although in the pre-calcined sample some oxidation of the silicon carbide does occur, it is to a substantially lesser extent compared to higher temperature calcination, for example at 1450° C.

FIG. 4 shows the results of thermogravimetric analysis of Examples 1 to 5 (labelled 1, 2, 3, 4 and 5 respectively) under a flow of air, and FIG. 5 shows corresponding plots of the change in weight with time during the experiment. The samples begin to show a loss in mass at temperatures between 600° C. and 700° C., which continues until a temperature of about 900° C. is reached.

FIG. 6 shows ²⁹Si MAS-NMR spectra for silicon carbide starting material, 10, and the sample of Example 2 at various stages of synthesis; after drying and before pre-calcination, 2a, after pre-calcination at 900° C. but before calcination at 1450° C., 2b, and after calcination at 1450° C., 2. FIG. 7 shows corresponding spectra for Example 3.

In the SiC reactant, 10, three peaks are apparent, these being assigned as phases corresponding to ordered β-SiC at −16.0 ppm, 14, disordered β-SiC at −22.2 ppm, 15, and α-SiC at −26.1 ppm, 16, as previously reported by Martin et al in J. Eur. Ceram. Soc., 1997, 17, 659-666. The resolution of these peaks is lower in the samples of Examples 2 and 3, although it is clear that SiC phases are still present. However, in the calcined samples 2 and 3 a well-defined downfield peak, 17, at about −112.6 ppm is also observed. This is assigned to Si in silica, which is consistent with the XRD data. There is also some evidence for a broader, yet less intense peak, in the pre-calcined samples 2b and 3b. This is also consistent with a more amorphous silica structure being present at lower quantities compared to the calcined samples.

FIG. 8 shows the total mercury intrusion volume of the calcined samples of Examples 1 to 5, (labelled 1, 2, 3, 4 and 5 respectively). It demonstrates that, on going to higher carbon ratios in the SiC/carbon mixture, a material with higher pore volume results. Table 1 lists the pore volumes and average pore diameters in the calcined samples. The pore volume increases with the relative carbon content of the initial SiC/Carbon mixture. This is consistent with the finding that the calcined SiC materials made using higher carbon content have a higher porosity, and a greater extent of pore connectivity. In addition, FIG. 9 shows the pore size distributions of the samples. It is clear that both the quantity of accessible pores and the average pore diameter increase where the calcined SiC materials are made using a higher carbon content, which is also consistent with a more open porous framework. The average pore diameters for the calcined samples of Examples 1 to 5 respectively are 0.25, 0.45, 1.34, 2.39 and 6.41 μm.

FIG. 10 shows scanning electron micrographs of the calcined samples of Examples 1 to 5. A gradual increase in pore sizes and pore connectivity is apparent when going from sample 1 through to sample 5, which corresponds to the porosity results shown in FIGS. 8 and 9. In sample 1, for example, the pores appear to be predominantly isolated, appearing as pits in the surface of the SiC structure, whereas in sample 5 the pores are highly interconnected, forming a network which clearly extends into the bulk of the SiC structure.

TABLE 1
Pore volumes and average pre diameters
for various calcined SiC samples.

| | SiC:C Weight | Pore Volume | Average Pore |
|---|---|---|---|
| Example | Ratio^{a} | (mL g⁻¹) | Diameter (μm) |
| 1 | 4:3 | 0.19 | 0.25 |
| 2 | 4:4 | 0.28 | 0.45 |
| 3 | 3:4 | 0.44 | 1.34 |
| 4 | 2:4 | 0.55 | 2.39 |
| 5 | 1:4 | 0.92 | 6.41 |

^{a}In the synthesis mixture before calcination or pre-calcination.

1.-14. (canceled)

15. A process for producing porous silicon carbide comprising:
(i) mixing particles of silicon carbide reactant with particles of carbon to form a mixture, wherein the solid components of the mixture are substantially silicon carbide and carbon only, and,
(ii) calcining the mixture in an atmosphere comprising molecular oxygen at a temperature in excess of 950° C.,
wherein the silicon carbide:carbon mass ratio in the mixture is in the range of from 5:1 to 1:10.

16. A process as claimed in claim 15, in which the pre-calcination and/or calcination are carried out in the presence of pure oxygen.

17. A process as claimed in claim 15, in which the calcination and/or pre-calcination is carried out at a pressure of at least 0.5 bara.

18. A process as claimed in claim 15, in which the calcination and/or pre-calcination is carried out at an oxygen partial pressure of at least 0.2 bara.

19. A process as claimed in claim 15, in which the weight ratio of silicon carbide reactant to carbon is in the range of from 4:3 to 1:10.

20. A process as claimed in claim 15, in which the weight ratio is 2:4 or more.

21. A process as claimed in claim 15, in which the average particle diameter of silicon carbide reactant is in the range of 0.05 to 50 μm, and the average particle diameter of carbon is in the range of from 0.1 to 100 μm.

22. A process as claimed in claim 15, in which the average particle diameter of silicon carbide reactant is smaller than that of the carbon.

23. A process as claimed in claim 22, in which the average particle diameter of the carbon is at least 10 times that of the average particle diameter of the silicon carbide reactant.

24. A process as claimed in claim 15, in which the temperature of calcination is in the range of from 1100 to 1600° C.

25. A process as claimed in claim 15, in which the mixture of silicon carbide reactant and carbon is pre-calcined in an oxygen-containing atmosphere at a temperature in the range of from 600 to 950° C.

26. A process as claimed in claim 15, in which the calcination and/or pre-calcination is carried out at a pressure of at least 0.1 bara.

27. A process as claimed in claim 15, in which the calcination and/or pre-calcination is carried out at an oxygen partial pressure of at least 0.1 bara.

28. A process for producing porous silicon carbide comprising mixing particles of silicon carbide reactant with particles of carbon, and calcining the mixture in an atmosphere comprising molecular oxygen at a temperature in excess of 950° C., wherein the silicon carbide:carbon mass ratio in the mixture is in the range of from 5:1 to 1:10.

29. A process as claimed in claim 19, wherein the porous silicon carbide is formed without addition of a coating to the silicon carbide.

30. A process as claimed in claim 28, in which the weight ratio of silicon carbide reactant to carbon is in the range of from 4:3 to 1:10.

31. A process as claimed in claim 28, in which the weight ratio is 2:4 or more.

32. A process as claimed in claim 28, in which the average particle diameter of silicon carbide reactant is in the range of 0.05 to 50 μm, and the average particle diameter of carbon is in the range of from 0.1 to 100 μm.

33. A process as claimed in claim 28, in which the average particle diameter of silicon carbide reactant is smaller than that of the carbon.

34. A process as claimed in claim 33, in which the average particle diameter of the carbon is at least 10 times that of the average particle diameter of the silicon carbide reactant.

35. A process as claimed in claim 28, in which the temperature of calcination is in the range of from 1100 to 1600° C.

36. A process as claimed in claim 28, in which the mixture of silicon carbide reactant and carbon is pre-calcined in an oxygen-containing atmosphere at a temperature in the range of from 600 to 950° C.

37. A process as claimed in claim 28, in which the calcination and/or pre-calcination is carried out at a pressure of at least 0.1 bara.

38. A process as claimed in claim 28, in which the calcination and/or pre-calcination is carried out at an oxygen partial pressure of at least 0.1 bara.
